(19) United States
(12) Patent Application Publication
(10) Pub. No.: US 2007/0257393 A1
(43) Pub. Date: Nov. 8, 2007

(54) MANUFACTURING METHOD OF AN ARTIFICIAL STRIP FOR IMITATED RATTAN/WILLOW FURNITURE AND A DEVICE SYSTEM THEREOF

(76) Inventor: Wei-Sung Chen, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/381,318

(22) Filed: May 2, 2006

(51) Int. Cl. B29C 47/00

(52) U.S. Cl. 264/75; 264/210.2; 425/382.3; 425/516

(57) ABSTRACT

A manufacturing method of an artificial strip for imitated rattan furniture is completed by steps of: inputting polyester plastic material with one color or two colors into at least one plastic extruder; thermal-melting the polyester plastic material to pour into a shaping molds, extruding the melted polyester plastic material in form of a continuous geometry strip so that the strip has at least one color on its surface; cooling the strip; twisting the strip to perform spiral wavy surface to enhance vivid appearance. Lastly, the strip is reeled up to achieve an annular bundle. Thereby, the artificial strip has a verisimilitude texture approximately like the natural willow or rattan strips to make the manufactured imitated rattan/willow furniture have excellent appearance. A device system carries out the manufacturing method is also disclosed in this invention.

### BACKGROUND OF THE INVENTION

1. Field of the Invention

The present invention relates to a manufacturing method of an artificial strip for imitated rattan/willow furniture, and more particularly to a manufacturing method that is to use polyester (PE) plastic material with a single color or at least two colors to manufacture a vivid artificial strip with a single color or at least two colors mixture in appearance by use of a device system comprising at least one plastic extruder, a shaping mold, a cooling water tank and a twisting device.

2. Description of Related Art

Natural rattan/willow strips is an important material for manufacturing furniture, baskets, boxes and other household objects. However, the household objects made of natural rattan/willow strips is not suitable for outdoor usage because the rattan/willow strips become soft and weaken after damping and even get rotten or moldy. Conventionally, the natural rattan/willow strips need to be processed by manpower before manufacturing the objects and then sopped into water until softening. Then, the natural rattan/willow strips enable to be shaped and alternatively waved in transversal and longitudinal directions on a corresponding frame to construct the objects. However, after the natural-style furniture becomes popular, price of the natural rattan/willow strip is tremendously increased because of source shortage.

In order to avoid the usage and shortage problems and of the conventional natural rattan/willow strips, furniture manufacturers all work on finding a new material to substitute the natural rattan/willow strips

### SUMMARY OF THE INVENTION

To overcome the drawbacks of the conventional problems in manufacturing furniture, an improved manufacturing method is provided to eliminate the drawbacks.

A main objective of the present invention is to provide a manufacturing method that produces an artificial strip imitating natural rattan/willow strips for manufacturing furniture.

Another main objective of the present invention is to provide a device system for practicing the foregoing manufacturing method to produce the artificial strip.

To achieve the foregoing objectives, the manufacturing method of an artificial strip for imitated rattan/willow furniture comprises steps of:

a) melting at least one polyester plastic material with at least one color;

b) extruding the melted polyester plastic material continuously in form of an extruded strip;

c) cooling the extruded strip until the extruded strip slightly solidifies;

d) twisting the extruded strip to perform spiral wavy surface thereon; and

e) reeling the extruded strip to achieve an annular bundle.

To achieve the foregoing objectives, the device system for manufacturing an artificial strip for imitated rattan/willow furniture comprises:

at least one extruder for melting at least one polyester plastic material with at least one color;

a shaping mold communicated with the at least one extruder for continuously shaping the at least one polyester plastic material into an extruded strip;

a cooling water tank for sopping the extruded strip until the extruded strip slightly solidifies;

a twisting device for twisting the extruded strip to perform spiral wavy surface thereon; and

a reeling device for reeling the extruded strip to achieve an annular bundle.

By the manufacturing method and the device system described above, the artificial strip has a verisimilitude texture approximately like the natural willow or rattan strip to make the manufactured imitated rattan/willow furniture have excellent appearance.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of imitated rattan/willow furniture in form of a chair made of an artificial strip in accordance with the present invention;

FIG. 2 is a schematic proceeding blocks of a first embodiment of a manufacturing method of the artificial strip in accordance with the present invention;

FIG. 3 is a schematic device system for the manufacturing method in FIG. 2;

FIG. 4-1 is a perspective view of a first artificial strip made by the manufacturing method in FIG. 2;

FIG. 4-2 is a cross-sectional view of the first artificial strip in accordance with the FIG. 4-1;

FIG. 4-3 is a perspective view of a second artificial strip made by the manufacturing method in FIG. 2;

FIG. 4-4 is a cross-sectional view of the second artificial strip in accordance with the FIG. 4-3;

FIG. 4-5 is a perspective view of a third artificial strip made by the manufacturing method in FIG. 2;

FIG. 4-6 is a cross-sectional view of the third artificial strip in accordance with the FIG. 4-5;

FIG. 5 is a schematic proceeding blocks of a second embodiment of the manufacturing method of artificial strips in accordance with the present invention;

FIG. 6 is a schematic device system for the manufacturing method in FIG. 5;

FIG. 7-1 is a perspective view of a first artificial strip made by the manufacturing method in FIG. 5;

FIG. 7-2 is a cross-sectional view of the first artificial strip in accordance with the FIG. 7-1;

FIG. 7-3 is a perspective view of a second artificial strip made by the manufacturing method in FIG. 5;

FIG. 7-4 is a cross-sectional view of the second artificial strip in accordance with the FIG. 7-3;

FIG. 7-5 is a perspective view of a third artificial strip made by the manufacturing method in FIG. 5; and

FIG. 7-6 is a cross-sectional view of the third artificial strip in accordance with the FIG. 7-5.

### DETAILED DESCRIPTION OF THE PREFERRED EMBODIMENT

A manufacturing method of an artificial strip for imitated rattan furniture in accordance with the present invention comprising steps of: inputting polyester plastic material with one color or two colors into at least one plastic extruder; thermal-melting the polyester plastic material to pour into a shaping molds, extruding the melted polyester plastic material in form of a continuous geometry strip so that the strip has at least one color on its surface; cooling the strip; twisting the strip to perform spiral wavy surface to enhance vivid appearance. Lastly, the strip is reeled up to achieve an annular bundle. Thereby, the artificial strip has a verisimilitude texture approximately like the natural willow or rattan strips to make the manufactured imitated rattan/willow furniture have excellent appearance. A device system carries out the manufacturing method is also disclosed in this invention.

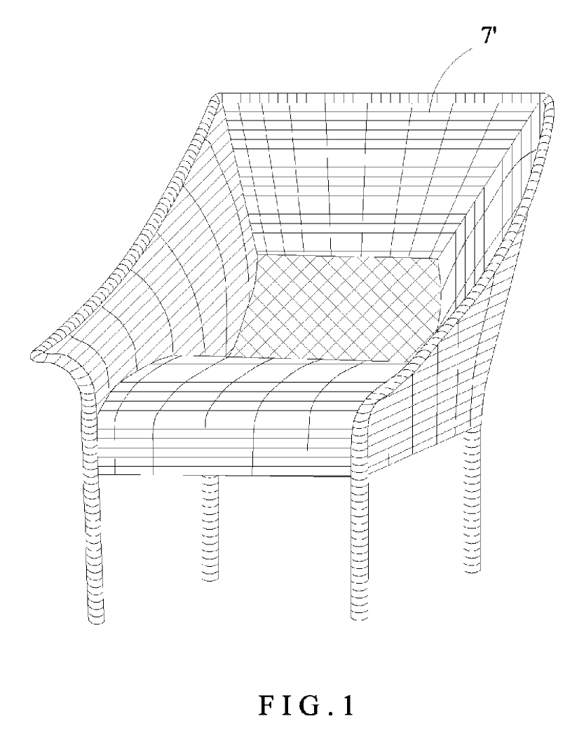

With reference to FIG. 1, a chair is made of multiple artificial strips manufactured by the method in the present invention, wherein the artificial strips are woven in transversal and longitudinal directions and have vivid appearance approximately like real rattan/willow strips but possess excellent durability.

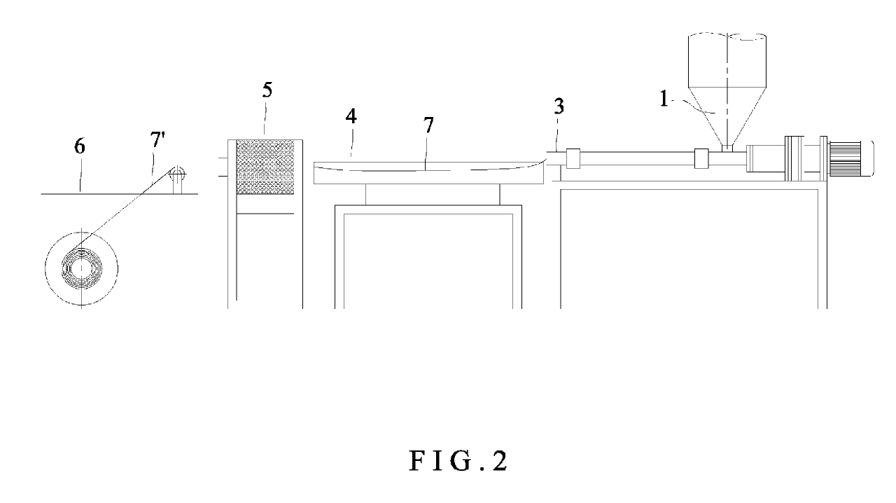

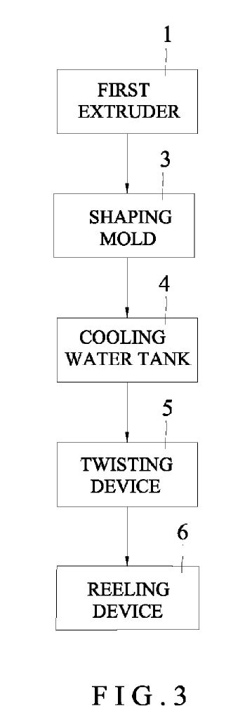

As shown in FIGS. 2 and 3, a first preferred embodiment of the manufacturing method for an artificial strip with a single color comprises steps of:

a) inputting a polyester plastic material with a single color into a first extruder 1, wherein the polyester plastic material is heated to melt and extruded at 190° C.-210° C.;

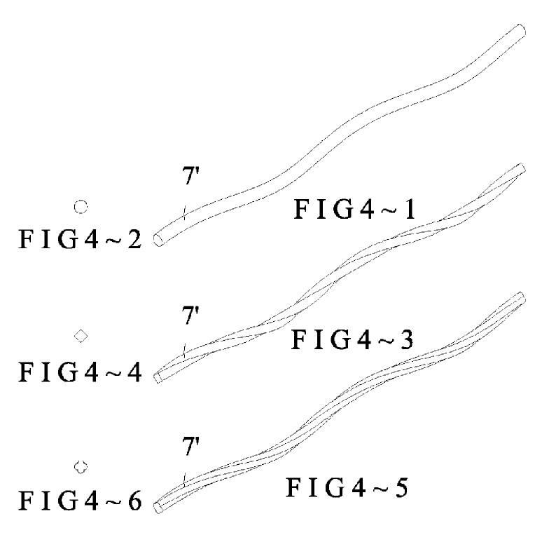

b) extruding the melted polyester plastic material from the first extruder 1 by a shaping mold 3 in form of a continuous strip, wherein the shaping mold 3 has various nozzle in cross-sections of round, rectangle or wavy periphery (as shown in FIGS. 4-1 to 4-6) changeable according to different products;

c) cooling an extruded strip 7 from the shaping mold 3 in a water tank 4 until the extruded strip 7 slightly solidifies;

d) twisting the extruded strip 7 by a twisting device to perform spiral wavy surface thereon after the extruded strip 7 passes the cooling water tank 4; and

e) reeling the extruded strip 7 from the twisting device 5 to achieve an annular bundle.

According to above manufacturing processes and the device system as shown in FIG. 2, the first extruder 1 melts the polyester plastic material and injected into the shaping mold 3. The melted polyester plastic material is continuously extruded out of the shaping mold 3 in shape corresponding to the cross-section of the outlet and then immediately sopped into the cooling water tank 4 for solidification. After slightly solidifying, the extruded strip 7 is twisted in the twisting device 5 to make its surface spirally wavy to achieve the artificial strip 7′ for imitated rattan/willow furniture. Lastly, the artificial strip 7′ is reeled up by the reeling device 6 and collected into an annular bundle for convenient transportation.

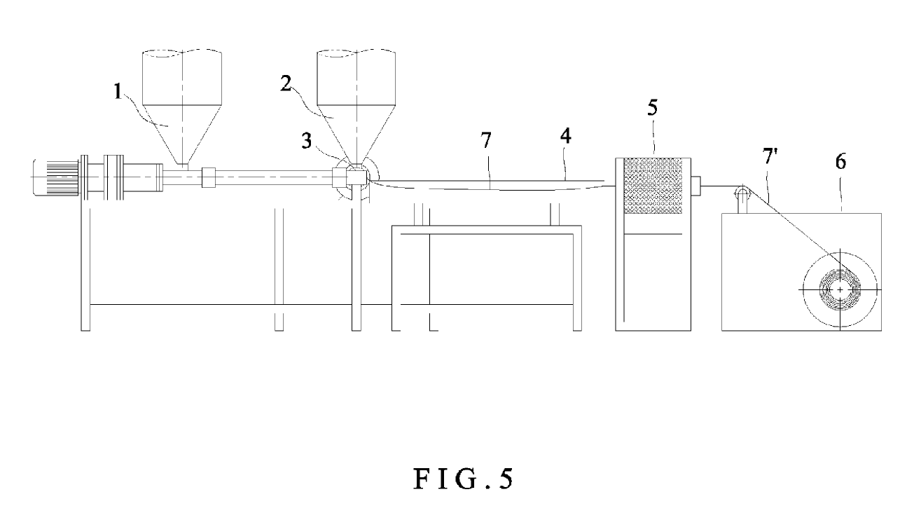

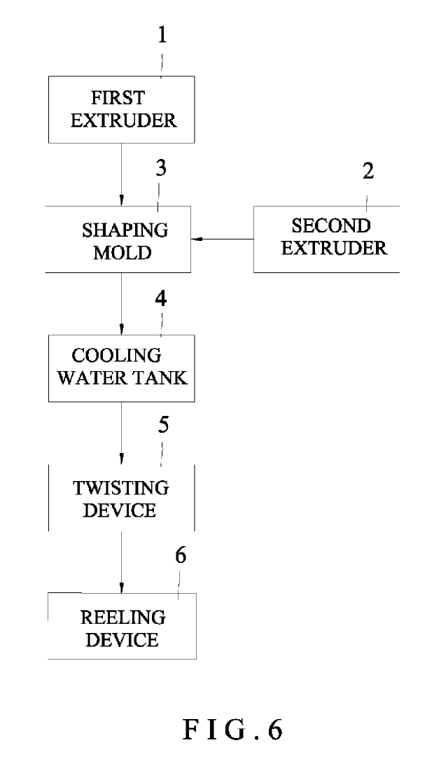

As shown in FIGS. 5 and 6, a second preferred embodiment of the manufacturing method of an artificial strip with two colors in mixture comprises steps of:

a) inputting one polyester plastic material with one color into a first extruder 1, wherein the plastic material is heated to melt and extruded at 190° C.-210° C.;

b) inputting another polyester plastic material with another color into a second extruder 2, wherein the polyester plastic material is heated to melt and extruded at 190° C.-210° C.;

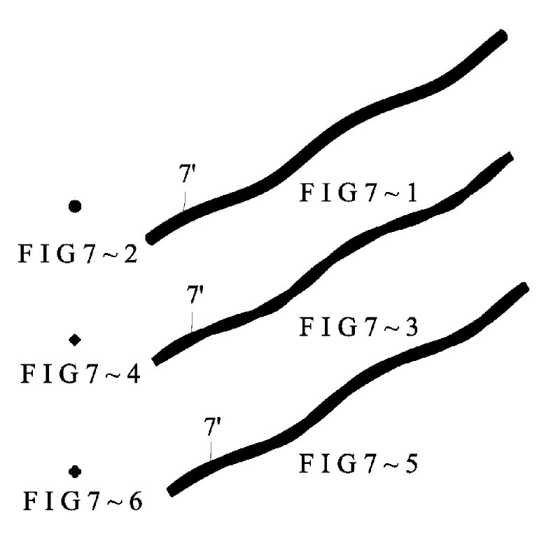

c) mixing and extruding the melted polyester plastic materials from the first extruder 1 and the second extruder 2 by a shaping mold 3 in form of a continuous strip with a dual-color random pattern, wherein the shaping mold 3 has various nozzle in cross-sections of round, rectangle or wavy periphery (as shown in FIGS. 7-1 to 7-6) changeable according to different products;

c) cooling an extruded strip 7 from the shaping mold 3 in a water tank 4 until the extruded strip 7 slightly solidifies;

d) twisting the extruded strip 7 by a twisting device to perform spiral wavy surface thereon after the extruded strip 7 passes the cooling water tank 4; and

e) reeling the extruded strip 7 from the twisting device 5 to achieve an annular bundle of the artificial strip.

According to above manufacturing processes and the device system as shown in FIG. 5, the first extruder 1 and the second extruder 2 melt the polyester plastic materials and injected into the shaping mold 3. The melted polyester plastic materials are mixed and continuously extruded out of the shaping mold 3 in shape corresponding to the cross-section of the outlet and then immediately sopped into the cooling water tank 4 for solidification. After slightly solidifying, the extruded strip 7 is twisted in the twisting device 5 to make its surface spirally wavy to achieve the artificial strip 7′ with a various dual-color random pattern for imitated rattan/willow furniture. Lastly, the artificial strip 7′ is reeled up by the reeling device 6 and collected into an annular bundle for convenient transportation.

Because the artificial strip is made of polyester plastic material, the imitated rattan/willow furniture does not easily become rotten or moldy even in an outdoor humid environment. By the manufacturing methods described above, the artificial strip has a verisimilitude texture approximately like the natural willow or rattan strips to make the manufactured imitated rattan/willow furniture have excellent appearance.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A manufacturing method of an artificial strip for imitated rattan/willow furniture comprising steps of:
a) melting a polyester plastic material with at least one color;
b) extruding the melted polyester plastic material continuously in form of an extruded strip;
c) cooling the extruded strip until the extruded strip slightly solidifies;
d) twisting the extruded strip to perform spiral wavy surface thereon; and
e) reeling the extruded strip to achieve an annular bundle of the artificial strip.

2. The manufacturing method as claimed in claim 1, wherein the step a) is of melting a polyester plastic material with one color and another polyester plastic material with another color;
the step b) is of extruding the melted polyester plastic material continuously in form of an extruded strip with a dual color random pattern.

3. A device system for manufacturing an artificial strip of imitated rattan/willow furniture comprises:
a first extruder for melting a polyester plastic material with a single color;
a shaping mold communicated with the first extruder for continuously shaping the polyester plastic material into an extruded strip;
a cooling water tank for sopping the extruded strip until the extruded strip slightly solidifies;
a twisting device for twisting the extruded strip to perform spiral wavy surface thereon; and
a reeling device for reeling the extruded strip to achieve an annular bundle.

4. A device system for manufacturing an artificial strip of imitated rattan/willow furniture comprises:
a first extruder for melting one polyester plastic material with one color;
a second extruder for melting another polyester plastic material with another color a shaping mold communicated with the first extruder and the second extruder for continuously shaping the polyester plastic materials into an extruded strip with a dual-color random pattern;
a cooling water tank for sopping the extruded strip until the extruded strip slightly solidifies;
a twisting device for twisting the extruded strip to perform spiral wavy surface thereon; and
a reeling device for reeling the extruded strip to achieve an annular bundle.

5. The device system as claimed in claim 3, wherein the shaping mold has an outlet in cross-sectional shape of round, rectangle or wavy periphery.

6. The device system as claimed in claim 4, wherein the shaping mold has an outlet in cross-sectional shape of round, rectangle or wavy periphery.
